(19) United States
(12) Patent Application Publication
(10) Pub. No.: US 2026/0161191 A1
(43) Pub. Date: Jun. 11, 2026

(54) REFERENCE CURRENT GENERATING CIRCUIT AND SEMICONDUCTOR DEVICE AND CONTROL METHOD THEREOF

(71) Applicant: Winbond Electronics Corp., Taichung City (TW)

(72) Inventor: Ying-Ting MA, Hsinchu County (TW)

(73) Assignee: Winbond Electronics Corp., Taichung City (TW)

(21) Appl. No.: 19/404,492

(22) Filed: Dec. 1, 2025

(30) Foreign Application Priority Data
Dec. 5, 2024 (TW) 113147154

(51) Int. Cl. G05F 3/26

(52) U.S. Cl. CPC G05F 3/262

(57) ABSTRACT

The invention provides a reference current generating circuit, a semiconductor device, and a control method thereof. The reference current generating circuit includes a current generator that outputs a normal reference current, a test reference current generating circuit, and a switching circuit. The test reference current generating circuit includes an operational amplifier and a first transistor. The operational amplifier is configured to receive a first voltage and a second voltage and generate a test reference current control signal. The first transistor is configured to generate a test reference current according to the first voltage and controlled by the test reference current control signal. The switching circuit is coupled to the current generator, the test reference current generating circuit, and an output node, and is configured to determine whether to output the normal reference current or the test reference current at the output node according to a mode control signal.

### CROSS REFERENCE TO RELATED APPLICATIONS

This application claims priority of Taiwan Patent Application No. 113147154 filed on Dec. 5, 2024, the entirety of which is incorporated by reference herein.

### BACKGROUND OF THE INVENTION

### Field of the Invention

The disclosure generally relates to a reference current generating circuit, and more specifically, to a reference current generating circuit, a semiconductor device and a control method thereof for improving circuit accuracy.

### Description of the Related Art

In integrated circuit design, the introduction of new processes frequently leads to numerous process variations, which can reduce overall circuit accuracy. To address the impact of these variations, integrated circuits typically employ a test procedure utilizing a bandgap voltage reference source. However, some parameters may not yield accurate reference values when relying solely on the bandgap voltage reference source. For example, integrated circuits often contain dedicated circuits, which supply reference currents to other circuits within the chip, thereby enabling precise timing control. Nevertheless, as process technology scales down, the variation in reference currents among different chips becomes larger. To achieve precise timing control, it is necessary to add a testing procedure in the integrated circuit test flow to measure and compensate for the reference current, and then use this compensated reference current for other test processes. As a result, testing costs increase. Accordingly, there is a need to propose a novel solution to overcome the challenges faced by the prior art.

### BRIEF SUMMARY OF THE INVENTION

In an embodiment, the invention proposes a reference current generating circuit. The reference current generating circuit includes a current generator that outputs a normal reference current, a test reference current generating circuit, and a switching circuit. The test reference current generating circuit includes an operational amplifier and a first transistor. The operational amplifier is configured to receive a first voltage and a second voltage and generate a test reference current control signal. The first transistor is controlled by the test reference current control signal, and is configured to generate a test reference current according to the first voltage. The switching circuit is coupled to the current generator, the test reference current generating circuit and an output node, and is configured to determine whether to output the normal reference current or the test reference current at the output node according to a mode control signal.

In another embodiment, the invention proposes a semiconductor device. The semiconductor device includes a resistor, a first pad, a second pad, and a reference current generating circuit. The first pad is coupled to the resistor. The first pad provides a first voltage. The second pad provides a second voltage. The reference current generating circuit includes a current generator that outputs a normal reference current, a test reference current generating circuit, and a switching circuit. The test reference current generating circuit includes an operational amplifier and a first transistor. The operational amplifier is configured to receive the first voltage and the second voltage and generate a test reference current control signal. The first transistor is controlled by the test reference current control signal, and is configured to generate a test reference current according to the first voltage. The switching circuit is coupled to the current generator, the test reference current generating circuit and an output node, and is configured to determine whether to output the normal reference current or the test reference current at the output node according to a mode control signal.

In another embodiment, the invention proposes a control method of a semiconductor device. The control method includes the steps of: determining whether to output a normal reference current or a test reference current at an output node of a reference current generating circuit via a switching circuit according to a mode control signal; when it is determined to output the normal reference current, outputting the normal reference current by connecting a current generator of the reference current generating circuit to the output node; when it is determined to output the test reference current, performing the following steps: receiving a first voltage and a second voltage and generating a test reference current control signal via an operational amplifier of the reference current generating circuit; and generating the test reference current via a first transistor according to the first voltage, wherein the first transistor is controlled by the test reference current control signal.

According to the reference current generating circuit, the semiconductor device and a control method thereof, the accuracy of the test reference current is enhanced. Also, the test process is simplified, so as to reduce the cost of the test.

### BRIEF DESCRIPTION OF DRAWINGS

FIG. 1 is a diagram of a reference current generating circuit according to an embodiment of the invention;

FIG. 2 to FIG. 4 are diagrams of circuitries of reference current generating circuits according to some embodiments of the invention; and

FIG. 5 is a flowchart of a control method of a semiconductor device according to an embodiment of the invention.

### DETAILED DESCRIPTION OF THE INVENTION

In order to illustrate the purposes, certain terms are used throughout the description and following claims to refer to particular components. Besides, the term “couple” is intended to mean either an indirect or direct electrical connection.

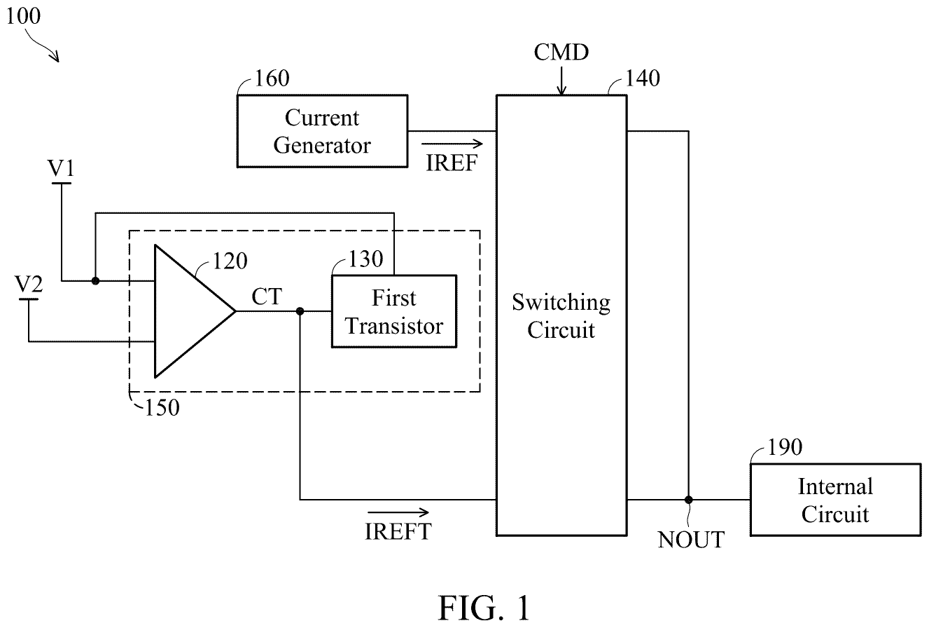

FIG. 1 is a diagram of a reference current generating circuit 100 according to an embodiment of the invention. The reference current generating circuit 100 may be applied to a variety of semiconductor devices, such as a mobile device or a memory device, but it is not limited thereto. The reference current generating circuit 100 is configured to generate a normal reference current IREF or a test reference current IREFT according to a mode control signal CMD. The reference current generating circuit 100 includes a switching circuit 140, a test reference current generating circuit 150, and a current generator 160. The test reference current generating circuit 150 includes an operational amplifier 120 and a first transistor 130. It should be understood that the reference current generating circuit 100 may further include other components, such as a processor and/or a power supply module, although they are not displayed in FIG. 1.

The operational amplifier 120 receives a first voltage V1 and a second voltage V2 and generates a test reference current control signal CT. The first transistor 130 is controlled by the test reference current control signal CT, and generates the test reference current IREFT according to the first voltage V1. The switching circuit 140 is coupled to the current generator 160, the test reference current generating circuit 150 and an output node NOUT, and is configured to determine whether to output the normal reference current IREF or the test reference current IREFT at an output node NOUT according to the mode control signal CMD. The current generator 160 outputs the normal reference current IREF.

The output node NOUT of the reference current generating circuit 100 is configured to drive an internal circuit 190 of the semiconductor device. According to practical measurements, the proposed reference current generating circuit 100 of the invention can increase the accuracy of the test reference current IREFT, thereby reducing the cost of the test and suppressing non-ideal error due to process variations. According to the proposed reference current generating circuit 100 of the invention, the test reference current IREFT can be directly obtained by the test reference current generating circuit 150, without any additional test processes for measuring and compensating for the reference current, especially in the development stage of introducing a new process. Next, the compensated reference current is used to perform other test processes.

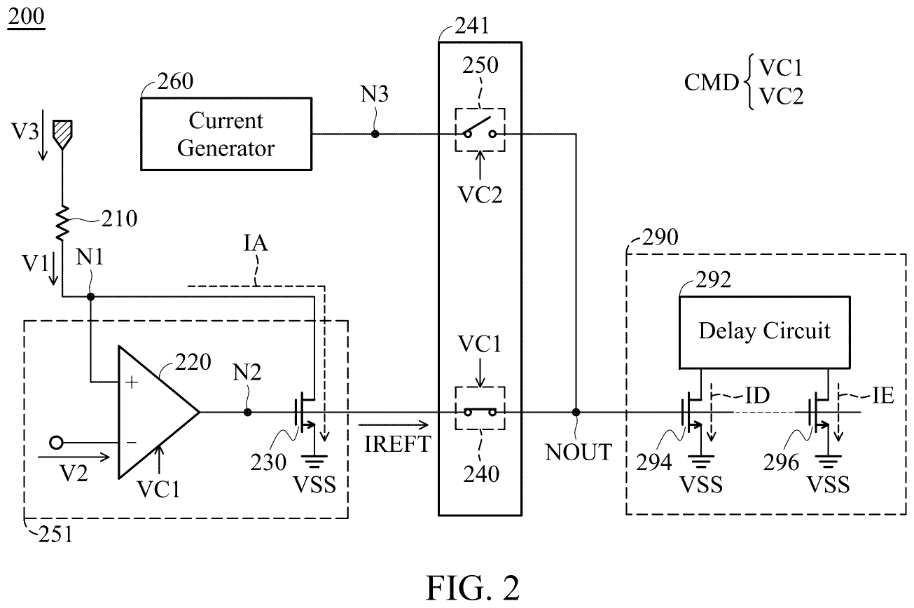

Specifically, as shown in FIG. 2, a switching circuit 241 of a reference current generating circuit 200 includes a first switch element 240 and a second switch element 250. The reference current generating circuit 200 may further include a resistor 210. The resistor 210 is coupled between a first node N1 and a third voltage V3, and is configured to receive the third voltage V3 and generate the first voltage V1. Also, the resistor 210 provides the first voltage V1 for the first node N1. The resistor 210 can provide a high-accuracy resistance. Thus, a first transistor 230 of a test reference current generating circuit 251 also generates the high-accuracy test reference current IREFT according to the first voltage V1.

In the embodiment, an operational amplifier 220 of the test reference current generating circuit 251 of the reference current generating circuit 200 has a positive input terminal coupled to the first node N1 for receiving the first voltage V1, a negative input terminal for receiving the second voltage V2, and an output terminal coupled to a second node N2. In some embodiments, the third voltage V3 is higher than the second voltage V2, and the resistor 210 is configured to make the first voltage V1 equal to or close to the second voltage V2. For example, the ratio of the third voltage V3 to the second voltage V2 may be from 1.1 to 2, and the ratio of the first voltage V1 to the second voltage V2 may be from 0.95 to 1.05, but the invention is not limited thereto.

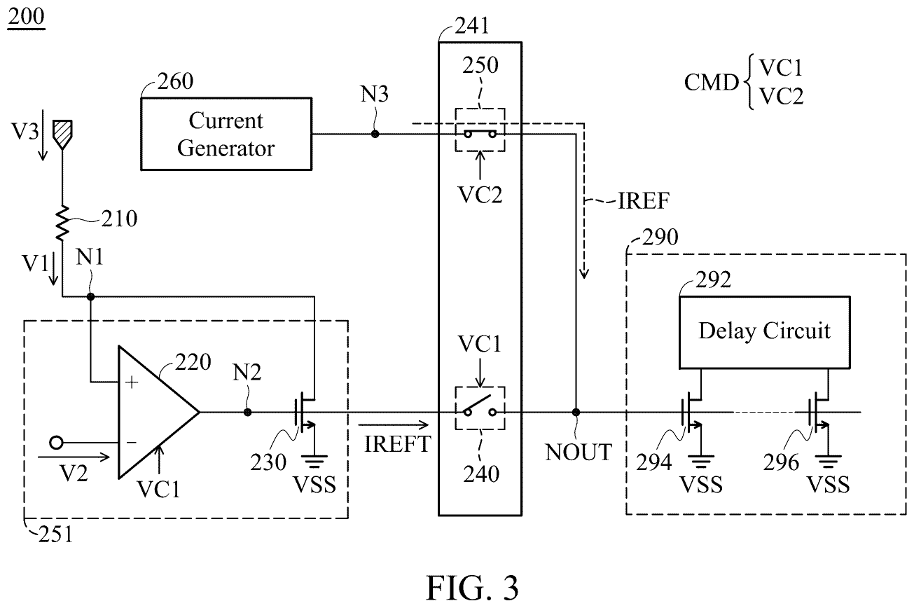

The reference current generating circuit 200 may operate in two modes, such as a test mode or a normal operation mode. The operational amplifier 220 may be selectively enabled according to the mode control signal CMD, thereby reducing unnecessary power consumption. For example, as shown in FIG. 2, when the mode control signal CMD indicates operation in the test mode, the operational amplifier 220 may be enabled according to the first control signal VC1 at a high logic level. As shown in FIG. 3, when the mode control signal CMD indicates operation in the normal operation mode, the operational amplifier 220 may be disabled according to the first control signal VC1 at a low logic level.

In the embodiment, the first transistor 230 may be an NMOS transistor. The first transistor 230 has a control terminal (e.g., a gate) coupled to the second node N2, a second terminal (e.g., a source) coupled to the ground voltage VSS, and a first terminal (e.g., a drain) coupled to the first node N1.

The first switch element 240 has a first terminal coupled to the second node N2, and a second terminal coupled to the output node NOUT. The second switch element 250 has a first terminal coupled to the third node N3, and a second terminal coupled to the output node NOUT. The first switch element 240 and the second switch element 250 may be selectively closed (conductive) or opened according to the mode control signal CMD. For example, as shown in FIG. 2, when the mode control signal CMD indicates operation in the test mode, the first switch element 240 may be closed according to the first control signal VC1 at a high logic level, so as to couple the output node NOUT to the second node N2. Also, the second switch element 250 may be opened according to the second control signal VC2 at a low logic level, so as to output the test reference current IREFT at the output node NOUT. As shown in FIG. 3, when the mode control signal CMD indicates operation in the normal operation mode, the first switch element 240 may be opened according to the first control signal VC1 at a low logic level. Also, the second switch element 250 may be closed according to the second control signal VC2 at a high logic level, so as to couple the output node NOUT to the third node N3. The internal circuit 290 is driven by the normal reference current IREF from the current generator 260.

In the embodiment, the mode control signal CMD includes the first control signal VC1 and the second control signal VC2. The first control signal VC1 and the second control signal VC2 may be generated by a processor according to a user input (not shown). In some embodiments, the first control signal VC1 and the second control signal VC2 have complementary logic levels. For example, if the first control signal VC1 has a high logic level, the second control signal VC2 may have a low logic level. Conversely, if the first control signal VC1 has a low logic level, the second control signal VC2 may have a high logic level. Thus, when one of the first switch element 240 and the second switch element 250 is closed, the other of the first switch element 240 and the second switch element 250 must be opened.

The current generator 260 outputs the normal reference current IREF to the third node N3. For example, the current generator 260 may be implemented with a current source, but it is not limited thereto.

The output node NOUT of the reference current generating circuit 200 is coupled to the other internal circuit 290 of the semiconductor device, such that the internal circuit 290 is driven by the reference current generating circuit 200. The internal circuit 290 includes a delay circuit 292, a second transistor 294, and a third transistor 296. The inner structure of the delay circuit 292 is not limited in the invention. For example, the delay circuit 292 may include one or more inverters coupled with each other. Each of the second transistor 294 and the third transistor 296 may be an NMOS transistor. In alternative embodiments, the internal circuit 290 includes more or less transistors.

The second transistor 294 has a control terminal coupled to the output node NOUT, a first terminal coupled to the ground voltage VSS, and a second terminal coupled to the delay circuit 292. In some embodiments, the size of the second transistor 294 is the same as that of the first transistor 230.

The third transistor 296 has a control terminal coupled to the output node NOUT, a first terminal coupled to the ground voltage VSS, and a second terminal coupled to the delay circuit 292. In some embodiments, the size of the third transistor 296 is the same as that of the first transistor 230.

In the embodiment, the first transistor 230 and the internal circuit 290 are both controlled by the test reference current control signal CT (which is generated on the second node N2). In other words, the first transistor 230 is configured as an input transistor of a current mirror, and the transistor of the internal circuit 290 is configured as an output transistor of the current mirror. In particular, the first transistor 230 and the second transistor 294 are configured to form a first current mirror, and the first transistor 230 and the third transistor 296 are configured to form a second current mirror. In the test mode, the operational principles of the reference current generating circuit 200 will be described according to the following equations (1) and (2):

$$IA = \frac{V 3 - V 2}{R} \qquad ( 1 )$$

$$ID = IE = IA \qquad ( 2 )$$

where “IA” represents the magnitude of a first current IA flowing through the first transistor 230, “V3” represents the voltage level of the third voltage V3, “V2” represents the voltage level of the second voltage V2, “R” represents the resistance of the resistor 210, “ID” represents the magnitude of a second current ID flowing through the second transistor 294, and “IE” represents the magnitude of a third current IE flowing through the third transistor 296.

Since the operational amplifier 220 has a feedback mechanism, there is a virtual short circuit formed between its positive input terminal and its negative input terminal, and the voltage at the first node N1 is the same as the second voltage V2. When the mode control signal CMD indicates operation in the test mode, based on Ohm's Law, the first current IA flowing through the resistor 210 and the first transistor 230 should be proportional to the voltage difference (i.e., V3−V2) between the third voltage V3 and the second voltage V2. The first current IA can almost have no error because the resistance of the resistor 210 is very precise. Next, the second current ID flowing through the second transistor 294 and the third current IE flowing through the third transistor 296 are basically the same as the first current IA flowing through the first transistor 230 by using the first current mirror and the second current mirror as mentioned above. Thus, when the reference current generating circuit 200 operates in the test mode, the internal circuit 290 receiving the test reference current IREFT can be driven by a high-accuracy output current (e.g., the second current ID and the third current IE), and the error of timing control of the internal circuit 290 can also be minimized.

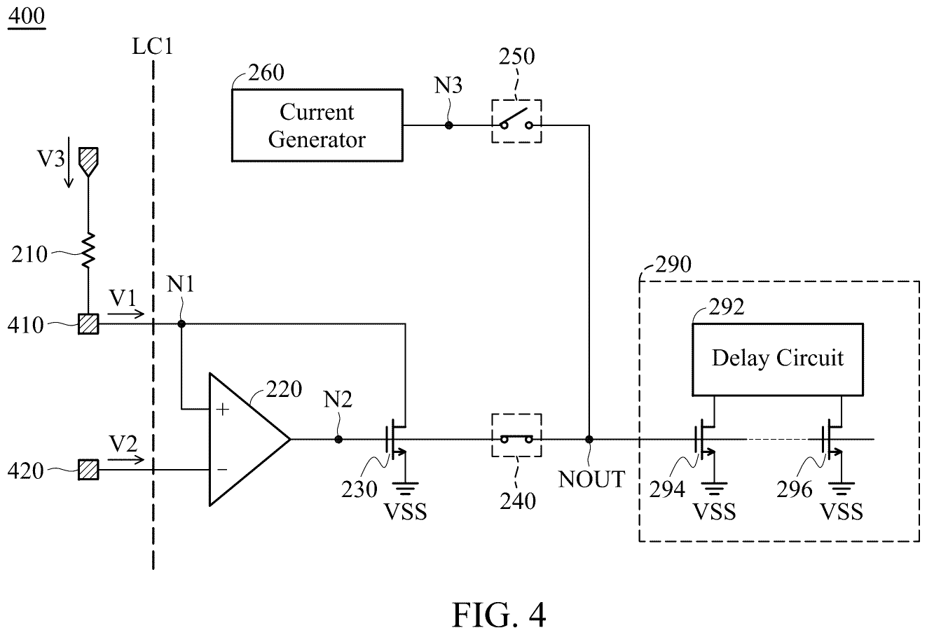

As shown in FIG. 4, a semiconductor device 400 according to an embodiment of the invention includes a first pad 410, a second pad 420, the resistor 210, and any one of the reference current generating circuits 100 and 200 illustrated in FIGS. 1, 2 and 3. The first pad 410 and the second pad 420 may be made of metal materials, but they are not limited thereto. Specifically, the first pad 410 is coupled to the resistor 210 and is configured to provide the first voltage V1. In addition, the second pad 420 is configured to provide the second voltage V2. In an embodiment, a test machine provides the third voltage V3 and the second voltage V2 for the resistor 210 and the second pad 420, respectively. Also, a plurality of resistors 210 are disposed on a test fixture respectively to connect to the first pads 410 of multiple chips. In one embodiment, the left and right of a virtual partition line LC1 are used to represent the outside and inside of a chip, respectively. That is, the first pad 410, the second pad 420 and the resistor 210 may be located outside the chip, while the operational amplifier 220, the first transistor 230, the first switch element 240, the second switch element 250 and the current generator 260 may be located inside the chip. It should be understood that various parameters of the aforementioned off-chip components can be more easily configured and calibrated to provide high accuracy, and they are not adversely affected by process variations associated with the chip. The other features of the embodiment of FIG. 4 are similar to those of the embodiments of FIGS. 1, 2 and 3, and they will not be described again herein.

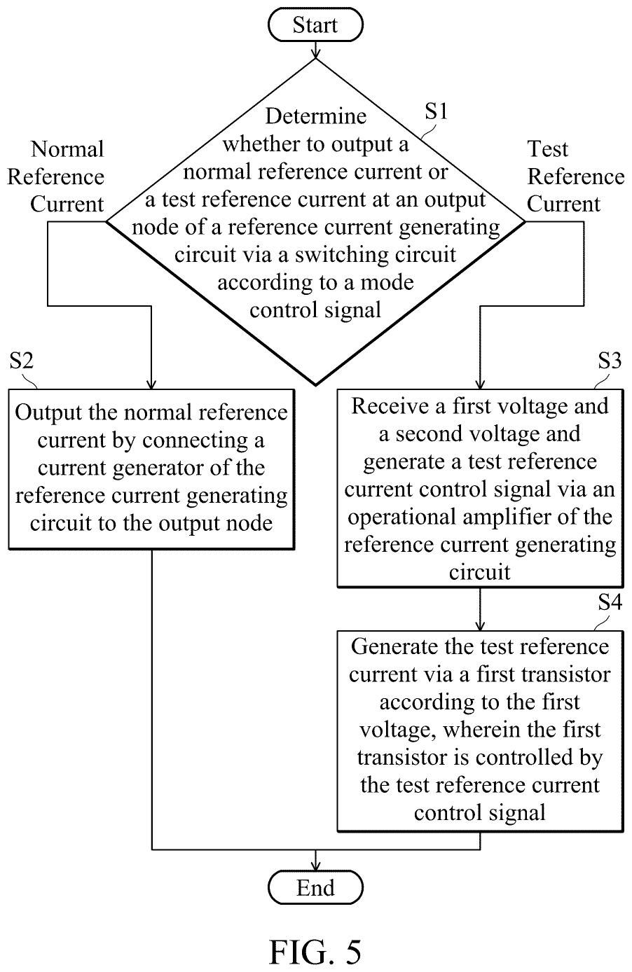

FIG. 5 is a flowchart of a control method of a semiconductor device according to an embodiment of the invention. These steps can be performed by the reference current generating circuits 100 and 200 or the semiconductor device 400 as shown in FIGS. 1 to 4. As shown in FIG. 5, in step S1, it is determined whether to output a normal reference current or a test reference current at an output node of a reference current generating circuit by a switching circuit according to a mode control signal. When it is determined to output the normal reference current, in step S2, the normal reference current is output by connecting a current generator of the reference current generating circuit to the output node. When it is determined to output the test reference current, the steps S3 and S4 are performed. In step S3, a first voltage and a second voltage are received and a test reference current control signal is generated by an operational amplifier of the reference current generating circuit. In step S4, the test reference current is generated by a first transistor according to the first voltage, and the first transistor is controlled by the test reference current control signal. Before the step S1, if the semiconductor operates in the test mode, a first voltage is provided by a first pad coupled to a resistor, and a second voltage is provided by a second pad. After the step S2 or S4, the normal reference current or the test reference current at the output node is copied, and then the copied normal reference current or the copied test reference current is provided for a delay circuit. The other steps and the detailed descriptions of the control method of the semiconductor device according to an embodiment of the invention are illustrated in the previous embodiments, and they will not be described again herein.

The invention provides a reference current generating circuit, a semiconductor device and a control method thereof, so as to enhance the accuracy of the test reference current, simplify the test process and reduce the cost of the test. Especially for miniaturized semiconductor devices, the test reference current generating circuit of the invention can directly provide an ideal or nearly ideal test reference current, without performing any new test processes for measuring and compensating the reference current, thereby reducing the cost of the test. In addition, according to the invention, since the ideal or close to ideal test reference current can be provided for the internal circuit in the test mode, problems with the internal circuit can be discovered more quickly and accurately, thereby improving the time control accuracy and the yield ratio of subsequent products.

In addition to enabling high-accuracy reference current generation, the present invention provides further benefits by integrating the operational amplifier. The operational amplifier's high gain and negative feedback actively suppress errors from noise, temperature drift, and supply variations, improving current stability. The operational amplifier can be selectively enabled or disabled via mode control signals to support test/normal operation switching and reduce power consumption. Moreover, the dual-pad configuration (a first pad supplying one voltage and a second pad supplying another) allows independent voltage control, better calibration, and improved isolation of parasitic effects, thereby enhancing measurement reliability and noise immunity. The operational amplifier's high input impedance and low output impedance also strengthen signal integrity and reduce channel interference in multi-die test environments, while its modularity facilitates scalability to different voltage ranges and test current levels and supports integration with digital control logic for automated and advanced test features.

Although the embodiments of the invention use MOSFET as examples, the invention is not limited thereto, and those skilled in the art may use other types of transistors, such as BJT (Bipolar Junction Transistor), JFET (Junction Gate Field Effect Transistor), FinFET (Fin Field Effect Transistor), etc., without affecting the performance of the invention.

It will be apparent to those skilled in the art that various modifications and variations can be made in the invention. It is intended that the standard and examples be considered exemplary only, with the true scope of the disclosed embodiments being indicated by the following claims and their equivalents.

What is claimed is:

1. A reference current generating circuit, comprising:
a current generator, outputting a normal reference current;
a test reference current generating circuit, comprising:
an operational amplifier, configured to receive a first voltage and a second voltage and generate a test reference current control signal; and
a first transistor, controlled by the test reference current control signal, and configured to generate a test reference current according to the first voltage; and
a switching circuit, coupled to the current generator, the test reference current generating circuit and an output node, and configured to determine whether to output the normal reference current or the test reference current at the output node according to a mode control signal.

2. The reference current generating circuit as claimed in claim 1, wherein the operational amplifier is configured to be selectively enabled according to the mode control signal.

3. The reference current generating circuit as claimed in claim 1, wherein the operational amplifier has a first input terminal for receiving the first voltage at a first node, a second input terminal for receiving the second voltage, and an output terminal coupled to a second node, and wherein the first transistor has a control terminal coupled to the second node, and a first terminal coupled to the first node.

4. The reference current generating circuit as claimed in claim 3, wherein the current generator is coupled to a third node, and wherein the switching circuit comprises:
a first switch element, disposed between the second node and the output node, and controlled by the mode control signal; and
a second switch element, disposed between the third node and the output node, and controlled by the mode control signal,
wherein when the mode control signal indicates a test mode, the first switch element is closed and the second switch element is opened, and when the mode control signal indicates a normal operation mode, the first switch element is opened and the second switch element is closed.

5. The reference current generating circuit as claimed in claim 3, further comprising:
a resistor, coupled to the first node, wherein the resistor is configured to receive a third voltage and generate the first voltage, and the third voltage is higher than the second voltage.

6. The reference current generating circuit as claimed in claim 1, wherein the second voltage is a bandgap voltage reference source.

7. The reference current generating circuit as claimed in claim 1, wherein the first voltage is equal to the second voltage.

8. The reference current generating circuit as claimed in claim 4, wherein the mode control signal comprises a first control signal and a second control signal, the first switch element receives the first control signal, the second switch element receives the second control signal, and the first control signal and the second control signal have complementary logic levels.

9. A semiconductor device, comprising:
a resistor;
a first pad, coupled to the resistor, and providing a first voltage;
a second pad, providing a second voltage; and
a reference current generating circuit, comprising:
a current generator, outputting a normal reference current;
a test reference current generating circuit, comprising:
an operational amplifier, configured to receive the first voltage and the second voltage and generate a test reference current control signal; and
a first transistor, controlled by the test reference current control signal, and configured to generate a test reference current according to the first voltage; and
a switching circuit, coupled to the current generator, the test reference current generating circuit and an output node, and configured to determine whether to output a normal reference current or the test reference current at the output node according to a mode control signal.

10. The semiconductor device as claimed in claim 9, further comprising:
a delay circuit; and
a second transistor, wherein the second transistor has a control terminal coupled to the output node, and a first terminal coupled to the delay circuit.

11. The semiconductor device as claimed in claim 9, wherein the operational amplifier, the first transistor, the switching circuit and the current generator are positioned inside a chip, and wherein the resistor, the first pad and the second pad are positioned outside the chip.

12. The semiconductor device as claimed in claim 9, wherein the operational amplifier is configured to be selectively enabled according to the mode control signal.

13. The semiconductor device as claimed in claim 9, wherein the operational amplifier has a first input terminal for receiving the first voltage at a first node, a second input terminal for receiving the second voltage, and an output terminal coupled to a second node, and wherein the first transistor has a control terminal coupled to the second node, and a first terminal coupled to the first node.

14. The semiconductor device as claimed in claim 13, wherein the current generator is coupled to a third node, and wherein the switching circuit comprises:
a first switch element, disposed between the second node and the output node, and controlled by the mode control signal; and
a second switch element, disposed between the third node and the output node, and controlled by the mode control signal,
wherein when the mode control signal indicates a test mode, the first switch element is closed and the second switch element is opened, and when the mode control signal indicates a normal operation mode, the first switch element is opened and the second switch element is closed.

15. The semiconductor device as claimed in claim 14, wherein the mode control signal comprises a first control signal and a second control signal, the first switch element receives the first control signal, the second switch element receives the second control signal, and the first control signal and the second control signal have complementary logic levels.

16. A control method of a semiconductor device, comprising:
determining whether to output a normal reference current or a test reference current at an output node of a reference current generating circuit via a switching circuit according to a mode control signal;
when it is determined to output the normal reference current, outputting the normal reference current by connecting a current generator of the reference current generating circuit to the output node;
when it is determined to output the test reference current, performing the following steps:
receiving a first voltage and a second voltage and generating a test reference current control signal via an operational amplifier of the reference current generating circuit; and
generating the test reference current via a first transistor according to the first voltage, wherein the first transistor is controlled by the test reference current control signal.

17. The control method of the semiconductor device as claimed in claim 16, further comprising:
determining whether to enable the operational amplifier according to the mode control signal.

18. The control method of the semiconductor device as claimed in claim 16, wherein when the mode control signal indicates a test mode, the test reference current is output at the output node, and when the mode control signal indicates a normal operation mode, the normal reference current is output at the output node.

19. The control method of the semiconductor device as claimed in claim 16, further comprising:
providing a first voltage via a first pad, wherein the first pad is coupled to a resistor;
providing a second voltage via a second pad; and
copying the normal reference current or the test reference current at the output node, and providing the copied normal reference current or the copied test reference current for a delay circuit.
